(19) United States
(12) Patent Application Publication
(10) Pub. No.: US 2018/0300464 A1
(43) Pub. Date: Oct. 18, 2018

(54) AUTHENTICATING USING A PASSWORD ENTRY PATTERN

(71) Applicant: International Business Machines Corporation, Armonk, NY (US)

(72) Inventors: Tamer A. Mahfouz, Cairo (EG); Nader M. Nassar, Yorktown Heights, NY (US); Tamer M. Nassar, Brookfield, CT (US); Hesham E. Soultan, Giza (EG); Alaa S. Youssef, Valhalla, NY (US)

(21) Appl. No.: 15/487,047

(22) Filed: Apr. 13, 2017

(51) Int. Cl. G06F 21/31; H04L 9/32

(52) U.S. Cl. CPC G06F 21/316; H04L 9/08; H04L 9/3239

(57) ABSTRACT

Embodiments of the invention are directed to a computer-implemented method, computer system, and computer program product for authenticating a user. The method includes receiving a userID. The method further includes retrieving a password entry pattern associated with the userID. Each password in the set of password entries is compared to the pre-established password entry pattern.

### BACKGROUND

The present invention relates in general to the field of computing. More specifically, the present invention relates to systems, methodologies and computer program products for controlling access to a computing device using challenge-response authentication.

When using a computer system, a user might be required to create an account in order to gain certain types of access. For example, a website might provide users with access to an account where the user is able to save certain information or make posts. Cryptographic credentials establish the identity of a party to an electronic, computer-based communication. Cryptographic credentials usually take the form of machine-readable cryptographic keys and/or passwords, which can be self-issued or issued by a trusted third party. In many contemporary cryptographic systems, the only criterion for issuance is unambiguous association of the credential with a specific, real individual or other entity.

### SUMMARY

Embodiments of the invention are directed to a computer-implemented method of authenticating a user. The method includes receiving a userID. The method further includes retrieving a password entry pattern associated with the userID. Each password in the set of password entries is compared to the pre-established password entry pattern.

Embodiments of the invention are directed to a computer-implemented method of authenticating a user. The method includes receiving userID. The method further includes reading a password entry pattern associated with the userID. The password entry pattern comprises a set of password entries P₁ through Pₙ, wherein each password entry P₁ through Pₙ is either a password entry or undefined. The method further includes receiving an i^{th} user entry for an iteration counter i. If the password entry for iteration i (Pi) is undefined, then the method includes receiving a user entry for a next iteration. If the password entry for iteration i (Pᵢ) is defined, then the method includes comparing the i^{th} user entry with Pᵢ, then the method includes receiving a user entry for a next iteration, if a user entry for the next iteration will occur. This process iterates n times.

Embodiments of the invention are further directed to a computer system of authenticating a user. The system includes a memory and a processor system communicatively coupled to the memory. The processor is configured to perform a method that includes receiving a userID. The method further comprises retrieving a password entry pattern associated with the userID. The method further comprises each password in the set of password entries is compared to the pre-established password entry pattern.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter that is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a flow diagram illustrating the operation of one or more user registration and pattern of passwords self-selection processes according to embodiments of the invention;

FIG. 2 depicts a flow diagram illustrating the operation of one or more user authentication using a pre-registered password pattern processes according to one or more embodiments of the invention;

FIG. 3 depicts a computer system capable of implementing hardware components of one or more embodiments of the invention; and

FIG. 4 depicts a diagram of a computer program product according to one or more embodiments of the invention.

### DETAILED DESCRIPTION

Various embodiments of the present invention will now be described with reference to the related drawings. Alternate embodiments can be devised without departing from the scope of this invention. Various connections might be set forth between elements in the following description and in the drawings. These connections, unless specified otherwise, can be direct or indirect, and the present description is not intended to be limiting in this respect. Accordingly, a coupling of entities can refer to either a direct or an indirect connection.

Additionally, although a detailed description of a computing device is presented, configuration and implementation of the teachings recited herein are not limited to a particular type or configuration of computing device(s). Rather, embodiments are capable of being implemented in conjunction with any other type or configuration of wireless or non-wireless computing devices and/or computing environments, now known or later developed.

Furthermore, although a detailed description of usage with specific devices is included herein, implementation of the teachings recited herein are not limited to embodiments described herein. Rather, embodiments are capable of being implemented in conjunction with any other type of electronic device, now known or later developed.

At least the features and combinations of features described in the immediately present application, including the corresponding features and combinations of features depicted in the figures amount to significantly more than implementing a method of authentication using a sequence of challenge-response actions. Additionally, at least the features and combinations of features described in the immediately following paragraphs, including the corresponding features and combinations of features depicted in the figures go beyond what is well understood, routine and conventional in the relevant field(s).

As previously described herein, there are situations in which a user needs to be authenticated before receiving access to a system. Common situations in which a user is authenticated include granting a user access to a website, a computer, or other type of account. The most common form of authentication is cryptographic credentials in the form of a combination of a username and a password. A username is a unique identifier that is associated with a user. The username can be an email address or other name that a user is able to remember for later access to the website or computer. Typically, each account for a particular system has a unique username associated with it. The password is a string of characters that, for optimum security, only the associated user knows.

Hackers or other bad actors sometimes want to gain access to a username and password to gain entry into a particular computer system. There are several methods that hackers use to gain such access. Common methods that can be used by hackers include brute force attacks, dictionary attacks, key loggers, and “over the shoulder” attacks. The term “hacker” as used in this specification refers to any person who uses computers to gain unauthorized access to data.

A simplified explanation of a brute force attack is when a hacker uses automation to attempt a large number of passwords with the hope of eventually guessing a correct username/password combination. A dictionary attack is a variation of a brute force attack in which a list of words (such as from a dictionary) is used as the password attempts. Both brute force and dictionary attacks can be prevented or made harder to implement by a user using more complex passwords. While a simple password (such as “passw0rd”) can be guessed by using lists of popular passwords, a more complex and longer password that is randomly generated is much more difficult to break with a brute force attack and is nearly impossible to break with a dictionary attack (because a random string of characters is unlikely to result in a word located in a dictionary). In actuality, a brute force attack or a dictionary attack might have several additional steps because most computer systems do not store passwords in a plain format. Instead, the password is hashed and/or salted. Thus, a hacker who obtains a list of usernames and passwords must also determine the hashing and/or salting in order to be successful with a particular hacking attempt.

Key logging (or “keystroke logging”) is the action of recording (logging) the keys struck on a keyboard so that the person using the keyboard is unaware that their actions are being monitored. Key logging can be used to determine the username and password for one or more websites or systems. A hacker using a key logger typically installs key logging software on an unsuspecting user's computer. The key logging software records every keystroke made by the user. By analyzing the record of keystrokes, a hacker can possibly determine a user's username and password.

An over-the-shoulder attack is when a hacker looks at the keyboard of a user as the user is entering in his username and password in an attempt to determine what keys the user was typing when he entered his password.

For the above reasons, websites and other computer systems often implement password rules. These rules can include a minimum length, a requirement to include both numbers and letters, a requirement to use both uppercase and lowercase letters, a requirement to periodically change the password, and the like. Unfortunately, users often do not choose the best passwords or protect their passwords in the most secure manner (for example, a user might use the same password for multiple accounts, use a weak password, keep a password for too long, save passwords in a browser, and the like).

One popular method to augment traditional passwords is to use two-factor authentication. Two-factor authentication (also known as multi-factor authentication) is a method of computer access control in which a user is granted access only after successfully presenting several separate pieces of evidence to an authentication mechanism. Typically, authentication involves at least two of the following categories: knowledge (something the user knows), possession (something the user has), and inherence (something the user is). An example of two-factor authentication is requiring both a password (something the user knows) and the use of an authenticator app on their phone, a code texted to the user, or a dongle or key fob that was issued to the user (something the user has possession of). An alternative example of two-factor authentication is requiring a password (something the user knows) with a fingerprint (something that the user is).

Two-factor authentication addresses some of the issues presented above. For example, even if a password is hacked, a hacker can still be prevented access to the computer or website unless the hacker has the second factor.

There are drawbacks to two-factor authentication. A user can be required to have an additional item in their possession. This can be a nuisance to users as they always have to have a special dongle or key fob with them to enter in the second authentication. Even for items that a user usually has with them (such as their smartphone), there can be issues if a user loses their smartphone.

Biometrics solves some of those problems (e.g., the user always has their fingerprint with them). However, requiring biometric entries can be expensive to implement, as biometric readers are not included in many computer systems. In addition, too heavy a reliance on biometrics can mean that leaked biometric information could be used to access multiple systems. In addition, biometrics can result in false negatives, as a user is not allowed access to a system due to a slight change in the user (e.g., the growth or removal of facial hair, the gain or loss of weight, or the presence/absence of glasses can fool facial recognition algorithms.

Embodiments of the present invention address the above-described issues by using a novel method and system to allow a user to authenticate themselves using a challenge-response paradigm. More particularly, a user can be prompted to enter a sequence of correct password(s) and other responses in order to gain access to a system or website.

In general, a system might have a traditional password system for authentication purposes. This can be a traditional password system that authenticates a user in a traditional manner using traditional minimum password requirements. In addition to the traditional password system, there can be an additional layer of protection in the form of a password entry pattern. The password entry pattern is the success or failure of a sequence of consecutive password entries. When a user creates or changes his password, the user can define additional parameters. The additional parameters can include a number of passwords, the content of the passwords, and the pattern of the passwords.

A password entry pattern is best illustrated with examples. In a first example, a user selects the number of passwords (one, in this example), the content of the password (e.g., password=“passlText”), the size of the pattern (two, in this example), and the pattern (e.g., password followed by dummy text that is not validated). It should be understood that although the phrase “dummy text” is used, the type of character is not necessarily limited to the alphabet or alphanumeric characters.

When the user attempts to log in to his account, he enters his user name. Then he is prompted to enter a password. After entering the first password, the user enters a second password. Only the first password would be checked to see if the password is correct. The content of the second password is not important and, in some embodiments, might not even be checked. In this case, only the user knows that the first password is an actual password and that the second “password” is a dummy entry. A hacker viewing the process (such as via an over-the-shoulder attack or via a key logger) might assume that the user merely entered the password wrong in the first attempt and believe that the second entry is the actual password. The hacker might not realize that the site relies on a password entry pattern system. In addition, attempts by the browser to save the password will not succeed because the browser does not know which attempt is real and which is not and might store the dummy password instead of the actual password.

Thus, over-the-shoulder attacks can be minimized due to several factors. One, there are more keystrokes for a hacker to perceive and memorize. Two, if the hacker can only memorize one of the passwords, the hacker is not sure which password is correct. In some embodiments, the user can be prompted to enter two passwords on a single screen. In some embodiments, the user is prompted to enter a password, then is prompted to enter a password again after the first entry is received.

In a second example, a user selects the number of passwords (one, in this example), the content of the password (e.g., password=“passlText”), the size of the pattern (three, in this example), and the pattern (e.g., dummy text followed by the password followed by dummy text).

When the user attempts to log in to his account, he enters his user name. Then he is prompted to enter a password three separate times (the size of the pattern in this example). Only the second entry would be checked to see if the password is correct. The content of the other two entries are ignored. In this case, only the user knows which password entry attempt is correct. Thus, over the shoulder attacks can be minimized. As above, there can be an embodiment in which the user is prompted for three passwords on a single screen. There also can be an embodiment where the user is prompted for a password three separate times on three separate entry screens.

In a third example, a user selects the number of passwords (two, in this example), the content of the passwords (e.g., password1=“pass1Text” and password2=“pass2Text”), the size of the pattern (four, in this example), and the pattern (e.g., password 2 followed by dummy text followed by password1 followed by dummy text).

When the user attempts to log in to his account, he enters his user name. Then he is prompted to enter four passwords (which is the size of the pattern). Only the first and third entries would be checked to see if the password is correct. As above, only the user knows which password entry is an actual password entry attempt and which entry will not be checked. Thus, over the shoulder attacks can be minimized even further.

As above, there can be an embodiment in which the user is separately prompted for a password four times on four separate screens. In such a manner, a hacker might not realize that a multi-password system is being used or might not realize which password is the correct password.

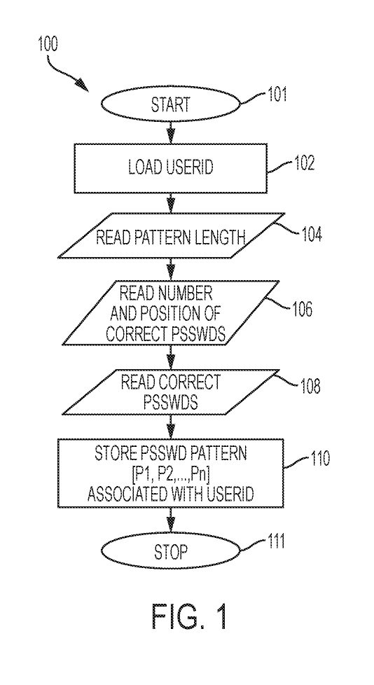

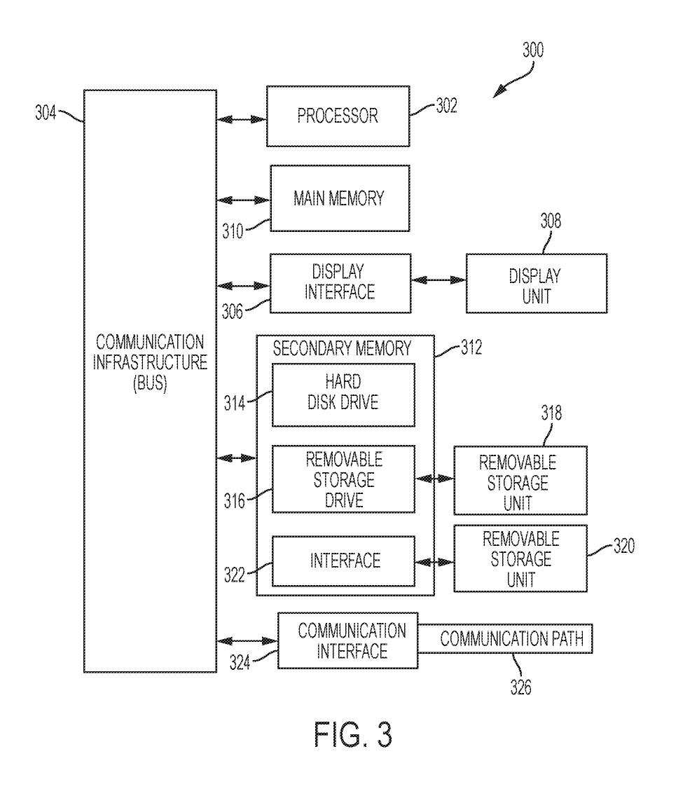

A flowchart illustrating method 100 is presented in FIG. 1. Method 100 is merely exemplary and is not limited to the embodiments presented herein. Method 100 can be employed in many different embodiments or examples not specifically depicted or described herein. In some embodiments, the procedures, processes, and/or activities of method 100 can be performed in the order presented. In other embodiments, one or more of the procedures, processes, and/or activities of method 100 can be combined or skipped. In some embodiments, portions of method 100 can be implemented by system 300 (FIG. 3).

Method 100 presents a flow for the registration of user on a system using an embodiment. After the method 100 starts (block 101), the method receives a userID input (block 102). The method can impose restrictions on the userID, check the userID against already existing userIDs to ensure that the userID is unique, and the like. There can be additional authentication measures requested here, such as an email address, an authentication sent to the email address, and other methods now known or developed in the future.

A pattern length is received from the user (block 104). As described above, the pattern length indicates how many times a user will be prompted for a password entry.

The number and position of the correct passwords is then received from the user (block 106). As described above, this can be in the form of informing an embodiment that the correct password will be the first entry or the second entry or the like. This information can be stored in a database in one of a variety of different manners. For example, a binary string can be created to indicate which entries are correct (indicated, for example, by a binary 1) or are dummy (indicated, for example, by a binary 0). So, a password sequence of dummy text followed by a correct password, followed by random text can be indicated by the sequence 010. Other storage methods can be used, such as the use of one of a variety of different types of databases (relational, SQL, key-value, NoSQL, and the like).

For each password in the sequence, the password text is received from the user (block 108). The received information is then stored in a database (block 110). In some embodiments, a set of variables is defined as P₁, P₂, through Pₙ, where n is the pattern length determined earlier. For each variable, the value can either be undefined, which indicates that the i^{th} entry is not an actual password but is dummy value. In the alternative, the variable can contain the actual stored password value. In some embodiments, instead of an undefined value, a predetermined value can be used to indicate the lack of an actual password for the i^{th} value.

In some embodiments, some or all of the information is hashed before being stored. In such a manner, even if a computer that stores password and userID information is hacked, the user accounts are still protected. For additional protection, the information can be combined with a salt value prior to the hashing, in a manner known in the art or developed in the future. Any one of many different hash functions can be used for this process. For example, an MD5 algorithm or a Secure Hash Algorithm (SHA) can be used for hashing.

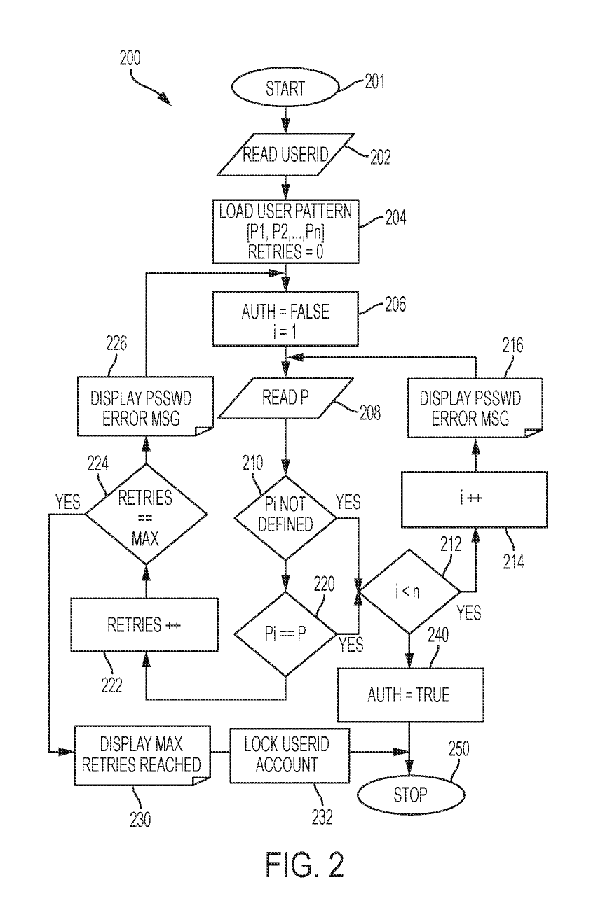

A flowchart illustrating method 200 is presented in FIG. 2. Method 200 is merely exemplary and is not limited to the embodiments presented herein. Method 200 can be employed in many different embodiments or examples not specifically depicted or described herein. In some embodiments, the procedures, processes, and/or activities of method 200 can be performed in the order presented. In other embodiments, one or more of the procedures, processes, and/or activities of method 200 can be combined or skipped. In some embodiments, portions of method 200 can be implemented by system 300 (FIG. 3).

Method 200 is the flow that can be followed when a user is attempting to log on to a system that uses an embodiment. A userID is received from a user (block 202). This can be received in one of a variety of different manners. In embodiments for on-line web access, a text box entry form can be presented to the user and set up to accept an entry of a userID. The user can be presented with a screen with an area for entry of his userID. This area can be the sole place to enter data or it can be one of several places on the screen that accepts entries (for example, one or more password entry areas can be present on the screen).

After receiving the userID, the userID is matched with a pre-existing account on the system. If the userID is not valid (for example, the userID does not have an account for a particular system), an indication can be presented to the user to enter the userID again.

After the userID is matched to a pre-existing user account, the user pattern associated with the userID is retrieved from a database (block 204). As described above, the pattern is the order of incorrect text entries and correct password entries selected by the user.

Initial variable values are then set (block 206). In some embodiments, the variables can include a counter variable i, which is set to 1, a logical variable Auth, which is set to False, and a Retry counter, which is set to 0.

A password is received from the user (block 208). The password can be received in one of a variety of different manners, both those now known or those developed in the future. In some embodiments, a text entry box is presented to a user on a display. The text entry box allows a user to enter text via one of a variety of entry methods, such as via a physical keyboard or a virtual (on-screen) keyboard. The text entry box can be accompanied by a button that a user activates to indicate that he is finished entering his password. In some embodiments, the typing of the Enter key can be accepted as the end of the password. In some embodiments, the password entry box is the only place where a user is able to enter text. In some embodiments, the password entry box can be presented along with the area where the user enters his userID.

It is determined if the Pᵢ entry is defined (block 210). In other words, the Pᵢ entry indicates whether or not an actual password is supposed to be a valid password. If the Pᵢ entry in the database indicates that the i^{th} password entry is not to be examined, action passes to block 212. Otherwise, the Pᵢ entry of the database is compared to the text entered by the user (block 220).

Block 212 is reached if either a correct password is received or if it does not matter if a correct password is received. At block 212, the method determines if the last entry has been received. In other words, at block 204, the method determined that there are n entries, indicating that a user has to submit n passwords in the correct pattern in order to be granted access. At block 212, it is determined if the counter i is less than n. If i is equal to n, then action proceeds with block 240, where the method changes the value of the logical Authenticated (Auth) variable to true. This indicates that the user is authorized to be granted access.

If i is less than n, then the variable i is incremented (block 214). A message is displayed to the user (block 216). In some embodiments, the message can be an error message. In some embodiments, the message can be a request to enter the password again. An advantage of such an approach is that it obfuscates (to a hacker) the fact that a multiple password system is in place. Thereafter, action returns to block 208.

If the password entry was incorrect at block 220, the Retry variable is incremented (block 222). Thereafter, the Retry variable is compared to the maximum number of retries available for each user. The maximum number of retries was set earlier at block 206. This value can be changed for each system and can be set by an administrator of the system. If the maximum number of retries has been reached, action moves to block 230, where a message is displayed to the user that the maximum number of retries has been reached. Thereafter, the account associated with the userID is locked (block 232) and the method is finished (block 250). The locking of a userID can be accomplished in one of a variety of different manners. For example, the locking can be temporary or it can be permanent.

If the maximum number of retries has not been reached, then a password error message is displayed to the user (block 226). Thereafter, operation returns to block 206.

In some embodiments, there is no indication that there is a pattern of passwords to be entered. Therefore, as the user enters passwords in accordance with the pattern, the system behaves as if all the password entries are incorrect single passwords, until the password entry pattern is recognized. At this point, method 200 recognizes that authorization has been granted. A hacker who does not realize that a pattern of passwords is being used will assume that a traditional single password system is being used and that the last entered password is the correct single password. Thus, in such embodiments, it can be advantageous to have the last password in a password entry pattern be an incorrect value.

In some embodiments, the user can reset the flow at any time. This can be accomplished in a variety of different manners. For a web-based embodiment, a user can refresh the browser to re-start method 200.

In some embodiments, the existence of a button on-screen to re-start method 200 can allow a user to begin the sequence again. This can be an implicit indication to the user that a sequence of passwords is to be used. In some embodiments, the number of entries made by the user (the variable n in method 200), is not displayed, to make it more difficult for a hacker to gain access.

To illustrate with an example, in an embodiment where the user is to enter five passwords, with the 4^{th} entry being an actual password. If the user gets the 4^{th} entry wrong, the entire sequence is wrong. The user expects the 5^{th} entry to result in a granting of access. When the user does not gain access, he can begin the sequence again by activating an on-screen button, to avoid confusion as to he is in the sequence of passwords.

In some embodiments, there can be a dynamic element to the entry of passwords. In such an embodiment, one of the “incorrect” password entries includes an embedded dynamic field. For example, the pattern can be incorrect text followed by password1, followed by the dynamic field.

The dynamic field is not a password, but rather is any text with dynamic content at a predetermined part of the field. For a simple example, the first two characters can be the current time in minutes, with the remainder of the dynamic field not being checked. In such a manner, a key logger cannot be used because a hacker using a key logger will be confused as to which of the three entries is the actual password. If the hacker just types in all three entries, it will be incorrect because the current time is supposed to be in the third password entry field and will result in no authorization if the same entry is tried at a later time. In addition, a browser will not be able to correctly store the password because it changes dynamically.

While a dynamic entry field such as described above can be used, more complex dynamic entries also can be used. An exemplary dynamic entry field can be as follows: “MMtext1DDtext2HHtext3 mm.” This indicates that what the user enters as text1, text2, and text3 are not checked (but should be a specific size, to account for the location of the date and time fields). However, the MM, DD, HH, and mm fields are compared to the current month, day, hour, and minute, respectively. Such a dynamic field prevents the successful use of a key logger, because the content of the field is not obvious at first glance. For example, the user would enter 09fydi26shff08mkui19, if the time when he enters the password is 8:19 on September 26. Someone who attempts to type that as a password entry at a different time will not be granted access. In some embodiments, the minute field can accept a small variation in input to take into account the fact that some clocks might show different times. In some embodiments, time zones are taken into account, such that a hacker is prevented from merely trying the entry exactly an hour later in a different time zone. In some embodiments, the date and time is checked against a centralized time server, to prevent a user from merely changing the time on his computer.

FIG. 3 depicts a high-level block diagram of a computer system 300, which can be used to implement one or more embodiments. More specifically, computer system 300 can be used to implement hardware components of systems capable of performing methods described herein. Although one exemplary computer system 300 is shown, computer system 300 includes a communication path 326, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 326, e.g., to communicate data between them. Computer system 300 can have one of a variety of different form factors, such as a desktop computer, a laptop computer, a tablet, an e-reader, a smartphone, a personal digital assistant (PDA), and the like.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, textual content, and other data from communication infrastructure 304 (or from a frame buffer not shown) for display on a display unit 308. Computer system 300 also includes a main memory 310, preferably random access memory (RAM), and can include a secondary memory 312. Secondary memory 312 can include, for example, a hard disk drive 314 and/or a removable storage drive 316, representing, for example, a floppy disk drive, a magnetic tape drive, or an optical disc drive. Hard disk drive 314 can be in the form of a solid state drive (SSD), a traditional magnetic disk drive, or a hybrid of the two. There also can be more than one hard disk drive 314 contained within secondary memory 312. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disc, etc. which is read by and written to by removable storage drive 316. As will be appreciated, removable storage unit 318 includes a computer-readable medium having stored therein computer software and/or data.

In alternative embodiments, secondary memory 312 can include other similar means for allowing computer programs or other instructions to be loaded into the computer system. Such means can include, for example, a removable storage unit 320 and an interface 322. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 320 and interfaces 322 which allow software and data to be transferred from the removable storage unit 320 to computer system 300.

Computer system 300 can also include a communications interface 324. Communications interface 324 allows software and data to be transferred between the computer system and external devices. Examples of communications interface 324 can include a modem, a network interface (such as an Ethernet card), a communications port, or a PC card slot and card, a universal serial bus port (USB), and the like. Software and data transferred via communications interface 324 are in the form of signals that can be, for example, electronic, electromagnetic, optical, or other signals capable of being received by communications interface 324. These signals are provided to communications interface 324 via communication path (i.e., channel) 326. Communication path 326 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 310 and secondary memory 312, removable storage drive 316, and a hard disk installed in hard disk drive 314. Computer programs (also called computer control logic) are stored in main memory 310 and/or secondary memory 312. Computer programs also can be received via communications interface 324. Such computer programs, when run, enable the computer system to perform the features discussed herein. In particular, the computer programs, when run, enable processor 302 to perform the features of the computer system. Accordingly, such computer programs represent controllers of the computer system. Thus it can be seen from the forgoing detailed description that one or more embodiments provide technical benefits and advantages.

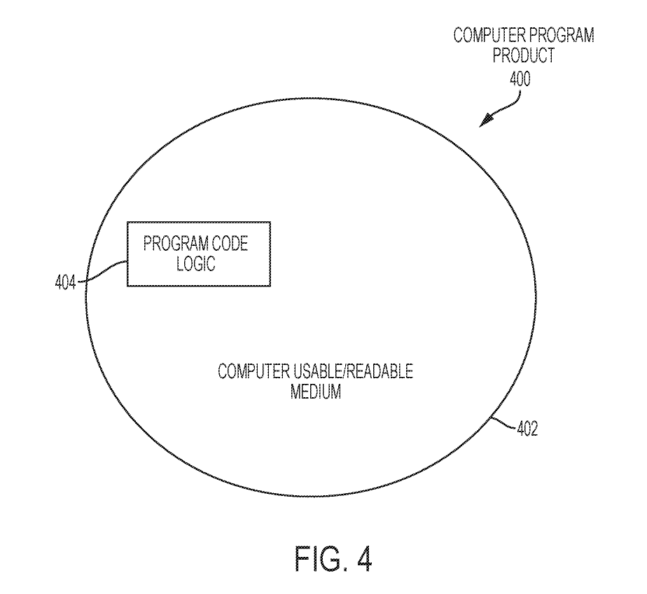

Referring now to FIG. 4, a computer program product 400 in accordance with an embodiment that includes a computer-readable storage medium 402 and program instructions 404 is generally shown.

Embodiments can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the consumer's computer, partly on the consumer's computer, as a stand-alone software package, partly on the consumer's computer and partly on a remote computer or entirely on the remote computer or server. In the latter scenario, the remote computer can be connected to the consumer's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The descriptions presented herein are for purposes of illustration and description, but is not intended to be exhaustive or limited. Many modifications and variations will be apparent to those of ordinary skill in the art without departing from the scope and spirit of embodiments of the invention. The embodiment was chosen and described in order to best explain the principles of operation and the practical application, and to enable others of ordinary skill in the art to understand embodiments of the present invention for various embodiments with various modifications as are suited to the particular use contemplated.

What is claimed is:

1. A computer-implemented method for authenticating a user, the method comprising:
receiving, by a processor, a user identification (userID);
retrieving, by the processor, a password entry pattern associated with the userID;
receiving, by the processor, a set of password entries; and
authenticating, by the processor, the user based at least in part on the password entry pattern matching a pre-established password entry pattern.

2. The computer-implemented method of claim 1, wherein:
the password entry pattern comprises a set of multiple entries; wherein at least one entry of the set of multiple entries is a password and at least one entry of the set of multiple entries is a dummy entry.

3. The computer-implemented method of claim 2, wherein authenticating the password entry pattern comprises:
determining which entry of the set of multiple entries is a password entry; and
authenticating password entries against a previously stored password entry.

4. The computer-implemented method of claim 3, wherein authenticating the password entry pattern comprises:
determining which entry of the set of multiple entries is a dummy entry; and
ignoring the dummy entry.

5. A computer-implemented method for authenticating a user, the method comprising:
receiving, by a processor, a user identification (userID);
reading, by the processor, a password entry pattern associated with the userID, wherein the password entry pattern comprises a set of password entries P₁ through Pₙ, wherein each password entry P₁ through Pₙ is either a password entry or undefined;
receiving, by the processor, an i^{th} user entry for an iteration counter i;
if the password entry for iteration i (Pᵢ) is undefined, then receiving a user entry for a next iteration;
if the password entry for iteration i (Pᵢ) is defined, then comparing the i^{th} user entry with Pᵢ then receive a user entry for a next iteration; and
iterating through n user entries to authenticate the user.

6. The computer-implemented method of claim 5, wherein:
comparing the i^{th} user entry with Pᵢ, comprises determining if a hash of the i^{th} user entry is equivalent to the hash of Pᵢ.

7. The computer-implemented method of claim 6, wherein the hash is selected from a SHA algorithm.

8. The computer-implemented method of claim 6, wherein the hash is salted before the comparison.

9. The computer-implemented method of claim 5, wherein iterating through n user entries comprises incrementing iteration counter i; and
iteratively performing the receiving the i^{th} user entry and comparing the i^{th} user entry with Pᵢ until i equals n.

10. The computer-implemented method of claim 9, further comprising displaying a password error message between each iteration.

11. The computer-implemented method of claim 5, further comprising allowing the user to reset the iteration counter i a predetermined number of times.

12. A computer system for authenticating a user, the system comprising:
a memory; and
a processor system communicatively coupled to the memory;
the processor system configured to:
receive a user identification (userID);
retrieving a password entry pattern associated with the userID;
receive a set of password entries; and
authenticate the user based at least in part on the password entry pattern matching a pre-established password entry pattern.

13. The computer system of claim 12, wherein:
the password entry pattern comprises a set of multiple entries; wherein at least one entry of the set of multiple entries is a password and at least one entry of the set of multiple entries is a dummy entry.

14. The computer system of claim 13, wherein authenticating the password entry pattern comprises:
determining which entry of the set of multiple entries is a password entry; and
authenticating password entries against a previously stored password entry.

15. The computer system of claim 14, wherein authenticating the password entry pattern comprises:
determining which entry of the set of multiple entries is a dummy entry; and
ignoring the dummy entry.

16. A computer system of claim 12, wherein the processor system is further configured to:
read a password entry pattern associated with the userID, wherein the password entry pattern comprises a set of password entries P₁ through Pₙ, wherein each password entry P₁ through Pₙ is either a password entry or undefined;
receive an i^{th} user entry for an iteration counter i;
if the password entry for iteration i (Pᵢ) is undefined, then receive a user entry for a next iteration;
if the password entry for iteration i (Pᵢ) is defined, then compare the i^{th} user entry with Pᵢ then receive a user entry for a next iteration; and
iterate through n user entries to authenticate the user.

17. The computer system of claim 16, wherein:
comparing the i^{th} user entry with Pᵢ comprises determining if a hash of the i^{th} user entry is equivalent to the hash of Pᵢ.

18. The computer system of claim 17, wherein the hash is selected from a SHA algorithm.

19. The computer system of claim 16, wherein iterating through n user entries comprises incrementing iteration counter i; and
iteratively performing the receiving the i^{th} user entry and comparing the i^{th} user entry with Pᵢ until i equals n.

20. The computer system of claim 16, further comprising allowing the user to reset the iteration counter i a predetermined number of times.
